(19) United States
(12) Patent Application Publication
(10) Pub. No.: US 2007/0081506 A1
(43) Pub. Date: Apr. 12, 2007

(54) On-vehicle device

(75) Inventor: Shuji Yamada, Kobe-shi (JP)

Correspondence Address: OLIFF & BERRIDGE, PLC, P.O. BOX 19928, ALEXANDRIA, VA, 22320, US

(73) Assignee: Fujitsu Ten Limited, Kobe-shi (JP)

(21) Appl. No.: 11/392,555

(22) Filed: Mar. 30, 2006

(30) Foreign Application Priority Data
Mar. 31, 2005 (JP) 2005-101054

(51) Int. Cl. H04Q 7/24

(52) U.S. Cl. 370/338

(57) ABSTRACT

Provided is an on-vehicle device capable of reducing an operation load on a user attempting connection by selecting a mobile communication terminal to be connected according to user's use state. An on-vehicle device which is mounted on a vehicle and can be connected to a plurality of mobile communication terminals includes a radio communication unit that is connected to the mobile communication terminals to perform radio communication. When the mobile communication terminal of the latest connection history is retrieved in a coverage area of the radio communication unit, the mobile communication terminal and the radio communication unit are connected to each other. When the mobile communication terminal of the latest connection history is not retrieved, a mobile communication terminal of a highest frequency of being connected to the radio communication unit is selected and connected to the radio communication unit each other.

### BACKGROUND OF THE INVENTION

1. Field of the Invention

The present invention relates to an on-vehicle device for connecting a mobile communication terminal such as a portable telephone to perform radio communication by a radio communication unit mounted on a vehicle.

2. Description of the Related Art

There has been known an on-vehicle terminal connected with a mobile communication terminal such as a portable telephone by harness to receive various pieces of information from an information center, another mobile communication terminal, a fixed telephone or the like through the mobile communication terminal and to provide the information to users. An on-vehicle terminal equipped with a radio communication unit represented by Bluetooth communication unit has recently been provided. In the on-vehicle device, the mobile communication terminal such as a portable telephone corresponding to the radio communication unit is connected to the radio communication unit to perform radio communication.

Any mobile communication terminal connected to the radio communication unit is used as long as the mobile communication terminal corresponds to the radio communication unit and exists in a coverage area of the radio communication unit. Accordingly, there is no problem if only one mobile communication terminal is present in the coverage area. However, if there are a plurality of relevant mobile communication terminals in the coverage area, there is problem that a mobile communication terminal to be connected needs to be selected before performing connection.

Japanese patent application laid-open No.2004-221890 discloses a technology regarding such connection between the radio communication unit and the mobile communication terminal. An on-vehicle communication terminal described therein includes a radio communication unit for performing radio communication with external mobile communication terminals to which different ID numbers are assigned, a storage unit for storing specific one of the registered ID numbers, an identification unit for identifying ID numbers of the mobile communication terminals in a communication area of the radio communication, a control unit for controlling the mobile communication terminal of the ID number stored in the storage unit among the mobile communication terminals whose ID numbers have been identified by the identification unit to perform various processing operations based on information received by the mobile communication terminal from the outside, and a display unit for displaying a menu screen on which an operator selects processing executed by the control unit when there is an ID number identical to that stored in the storage unit among the ID numbers identified by the identification unit.

### SUMMARY OF THE INVENTION

According to the above-described on-vehicle communication terminal, when the mobile communication terminal of the registered ID number is in the communication area of the short-distance radio communication, this mobile communication terminal is controlled to be used, and the menu screen is displayed so that the user can select processing contents to be executed. As a result, once the ID number of the mobile communication terminal to be used is registered, a mobile communication terminal does not need to be selected for each use, and processing contents can be quickly selected.

According to the on-vehicle communication terminal, when the connection is controlled based on the registered ID number, and presence of ID numbers of the plurality of mobile communication terminals in the communication area is determined, the connection is controlled based on priority set on each ID number.

However, the mobile communication terminal to be used (connected) is properly changed according to a use state or the like. When the mobile communication terminal to be connected is selected based on the priority, there is a risk that a mobile communication terminal unintended by the user will be connected. It may take time to retrieve and select a next mobile terminal.

The present invention has been developed with the foregoing problems in mind, and it is an object of the present invention to provide an on-vehicle device capable of decreasing the number of times of selecting communication terminals unintended by a user to reduce an operation load on the user by selecting a mobile communication terminal to be connected according to user's use state when the mobile communication terminal is connected to a radio communication unit.

The present invention is configured as follows to solve the aforementioned technical problems.

According to an aspect of the present invention, an on-vehicle device which is mounted on a vehicle and can be connected to a plurality of mobile communication terminals includes: a radio communication unit that is connected to the mobile communication terminals to perform radio communication; a connection history storage unit that stores connection history of the mobile communication terminals connected to the radio communication unit; a terminal retrieval unit that retrieves mobile communication terminals in a coverage area of the radio communication unit; a latest terminal retrieval unit that retrieves a mobile communication terminal whose connection history stored in the connection history storage unit is latest among the mobile communication terminals retrieved by the terminal retrieval unit; and a connection control unit that, when the latest terminal retrieval unit retrieves the mobile communication terminal of the latest connection history, connects the mobile communication terminal and the radio communication unit to each other, and that, when the latest terminal retrieval unit does not retrieve the mobile communication terminal of the latest connection history, selects a mobile communication terminal of a highest frequency of being connected to the radio communication unit to connect the mobile communication terminal and the radio communication unit to each other.

According to another aspect of the present invention, an on-vehicle device which is mounted on a vehicle and can be connected to a plurality of mobile communication terminals includes: a radio communication unit that is connected to pre-reregistered mobile communication terminals to perform radio communication; a registration reception unit that receives registration of the mobile communication terminals to be connected to the radio communication unit; a connection history storage unit that stores connection history of the mobile communication terminals connected to the radio communication unit; a terminal retrieval unit that retrieves mobile communication terminals in a coverage area of the radio communication unit; a latest terminal retrieval unit that retrieves a mobile communication terminal whose connection history stored in the connection history storage unit is latest among the mobile communication terminals retrieved by the terminal retrieval unit; and a connection control unit that, when the latest terminal retrieval unit retrieves the mobile communication terminal of the latest connection history, connects the mobile communication terminal and the radio communication unit to each other, and that, when the latest terminal retrieval unit does not retrieve the mobile communication terminal of the latest connection history, selects a mobile communication terminal of a latest date of registration in the registration reception unit to connect the mobile communication terminal and the radio communication unit to each other.

According to another aspect of the present invention, an on-vehicle device which is mounted on a vehicle and can be connected to a plurality of mobile communication terminals includes: a radio communication unit that is connected to the mobile communication terminals to perform radio communication; a connection history storage unit that stores connection history of the mobile communication terminals connected to the radio communication unit; a terminal retrieval unit that retrieves mobile communication terminals in a coverage area of the radio communication unit; a latest terminal retrieval unit that retrieves a mobile communication terminal whose connection history stored in the connection history storage unit is latest among the mobile communication terminals retrieved by the terminal retrieval unit; and a connection control unit that, when the latest terminal retrieval unit retrieves the mobile communication terminal of the latest connection history, connects the mobile communication terminal and the radio communication unit to each other and that, when the latest terminal retrieval unit does not retrieve the mobile communication terminal of the latest connection history, selects a mobile communication terminal of the latest connection history of the other mobile communication terminals to connect the mobile communication terminal and the radio communication unit to each other.

According to the on-vehicle device of the present invention, when there are a plurality of mobile communication terminals in the coverage area of the radio communication unit, first, the mobile communication terminal of the latest connection history is selected to be connected. When the mobile communication terminal is not retrieved, a mobile communication terminal is selected to be connected based on the connection history. In other words, as the terminal to be connected to the radio communication unit is selected based on the connection history, it is possible to properly change order of connection priority according to user's use state, and to reduce an operation load on the user during the connection.

According to another aspect of the present invention, an on-vehicle device which is mounted on a vehicle and can be connected to a plurality of mobile communication terminals includes: a radio communication unit that is connected to the mobile communication terminals to perform radio communication; a connection history storage unit that stores connection history of the mobile communication terminals connected to the radio communication unit; a terminal retrieval unit that retrieves mobile communication terminals in a coverage area of the radio communication unit; a connection setting reception unit that receives beforehand setting of one mobile communication terminal to be connected to the radio communication unit among the plurality of mobile communication terminals; and a connection control unit that, when the terminal retrieval unit retrieves the mobile communication terminal set in the connection setting reception unit, connects the mobile communication terminal and the radio communication unit to each other, and that, when the terminal retrieval unit does not retrieve the mobile communication terminal set in the connection setting reception unit, selects a mobile communication terminal of a highest frequency of being connected to the radio communication unit to connect the mobile communication terminal and the radio communication unit to each other.

According to another aspect of the present invention, an on-vehicle device which is mounted on a vehicle and can be connected to a plurality of mobile communication terminals includes: a radio communication unit that is connected to pre-reregistered mobile communication terminals to perform radio communication; a registration reception unit that receives registration of the mobile communication terminals to be connected to the radio communication unit; a terminal retrieval unit that retrieves mobile communication terminals in a coverage area of the radio communication unit; a connection setting reception unit that receives beforehand setting of one mobile communication terminal to be connected to the radio communication unit among the plurality of mobile communication terminals; and a connection control unit that, when the terminal retrieval unit retrieves the mobile communication terminal set in the connection setting reception unit, connects the mobile communication terminal and the radio communication unit to each other, and that, when the terminal retrieval unit does not retrieve the mobile communication terminal set in the connection setting reception unit, selects a mobile communication terminal of a latest date of registration in the registration reception unit to connect the mobile communication terminal and the radio communication unit to each other.

According to another aspect of the present invention, an on-vehicle device which is mounted on a vehicle and can be connected to a plurality of mobile communication terminals includes: a radio communication unit that is connected to the mobile communication terminals to perform radio communication; a connection history storage unit that stores connection history of the mobile communication terminals connected to the radio communication unit; a terminal retrieval unit that retrieves mobile communication terminals in a coverage area of the radio communication unit; a connection setting reception unit that receives beforehand setting of one mobile communication terminal to be connected to the radio communication unit among the plurality of mobile communication terminals; and a connection control unit that, when the terminal retrieval unit retrieves the mobile communication terminal set in the connection setting reception unit, connects the mobile communication terminal and the radio communication unit to each other, and that, when the terminal retrieval unit does not retrieve the mobile communication terminal set in the connection setting reception unit, selects a mobile communication terminal whose connection history stored in the connection history storage unit is latest to connect the mobile communication terminal and the radio communication unit to each other.

According to the on-vehicle device of the present invention, when there are a plurality of mobile communication terminals in the coverage area of the radio communication unit, first, one mobile communication terminal preset in the connection setting reception unit is selected to be connected. When the mobile communication terminal is not retrieved, the mobile communication terminal to be connected is selected based on the connection history. In other words, as the mobile communication terminal to be connected to the radio communication unit is selected based on user's wish and the connection history, it is possible to properly change order of connection priority according to user's use state, and to reduce an operation load on the user during the connection.

The on-vehicle device of the present invention may further include a reconnection control unit that prompts the connection control unit to reconnect the mobile communication terminal and the radio communication unit when the connection is cut off while the radio communication unit and the mobile communication terminal are connected. The connection control unit may preferentially connect the mobile communication terminal and the radio communication unit which have been disconnected when the reconnection between mobile communication terminals and the radio communication unit is established.

The connection between the radio communication unit and the mobile communication terminal may be cut off due to various causes such as lack of power of the mobile communication terminal, an erroneous operation, and electronic jamming by obstacles. In such a case, the mobile communication terminal to be reconnected can be retrieved. However, when a mobile communication terminal present in the coverage area is retrieved all over again according to the connection history or the like, processing may take a long time to extend disconnection time. Especially when the mobile communication terminal is disconnected during calling, it must be quickly reconnected. With this configuration, the disconnected mobile communication terminal can be preferentially connected to reduce troubles caused by the disconnection.

The on-vehicle device according to the present invention may further include a user detection unit that determines whether a user is in a seat of the vehicle or not, and the connection control unit may control the connection between the mobile communication terminal and the radio communication unit when the user detection unit detects the user's existence.

The presence of the user detection unit enables the determination as to whether a user having a mobile communication terminal is in the vehicle or not, and thereby the existence of the mobile communication terminal in the vehicle can be understood accurately, and a connection between the mobile communication terminal and the radio communication unit can be established.

For example, when the user of the mobile communication terminal connected to the radio communication unit moves out of the vehicle in use, the mobile communication terminal may be retrieved again unless whether the mobile communication terminal is in the vehicle or not can be determined. Even when the mobile communication terminal is not present, quick processing may be blocked by repeating the retrieving operation, causing continuance of the impossible state of radio communication performance. However, by disposing the user detection unit that determines whether the user is in the vehicle or not, the existence of the user can be recognized, and connection work can be efficiently carried out.

Furthermore, according to the on-vehicle device of the present invention, preferably, the radio communication unit performs radio communication of Bluetooth system. According to the present invention, any radio communication unit can be used as long as it is connected to the mobile communication terminal such as a portable telephone to perform radio communication. Though not limitative, the radio communication of the Bluetooth system can be suitably used for the on-vehicle device limited in installation place as it is compact and consumes less power.

As described above, according to the on-vehicle device of the present invention, since the mobile communication terminal is selected according to user's use state when the mobile communication terminal is connected to the radio communication unit, it is possible to reduce an operation load on the user.

### BRIEF DESCRIPTION OF THE DRAWINGS

FIG. 1 is a diagram showing a configuration of a communication system which uses an on-vehicle device of the present invention.

FIG. 2 is a diagram showing a configuration of the on-vehicle device of the present invention.

FIG. 3 is a flowchart showing a procedure in an on-vehicle device according to a first embodiment.

FIG. 4 is a table showing a mobile communication terminal DB stored in the on-vehicle device of the present invention.

FIG. 5 is a flowchart showing a procedure in an on-vehicle device according to a second embodiment.

FIG. 6 is a flowchart showing a procedure in an on-vehicle device according to a third embodiment.

### DETAILED DESCRIPTION OF THE PREFERRED EMBODIMENT

<First Embodiment>

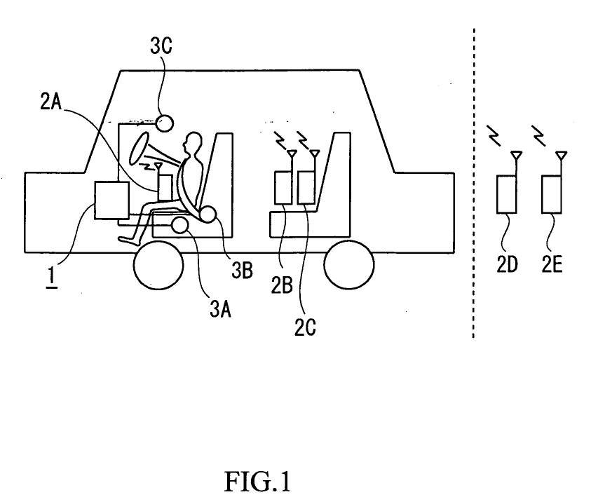

The preferred embodiments of the present invention will be described below in detail with reference to the drawings. FIG. 1 is a diagram showing a configuration of a communication system which uses an on-vehicle device of a first embodiment. The communication system includes an on-vehicle device 1 mounted on a vehicle, mobile communication terminals 2A to 2C connectable to the on-vehicle device 1, mobile communication terminals 2D and 2E which are in an unconnectable state (outside coverage area) to the on-vehicle device 1, and sensors 3A to 3C as user detection units for determining whether a driver is in driver's seat of the vehicle or not.

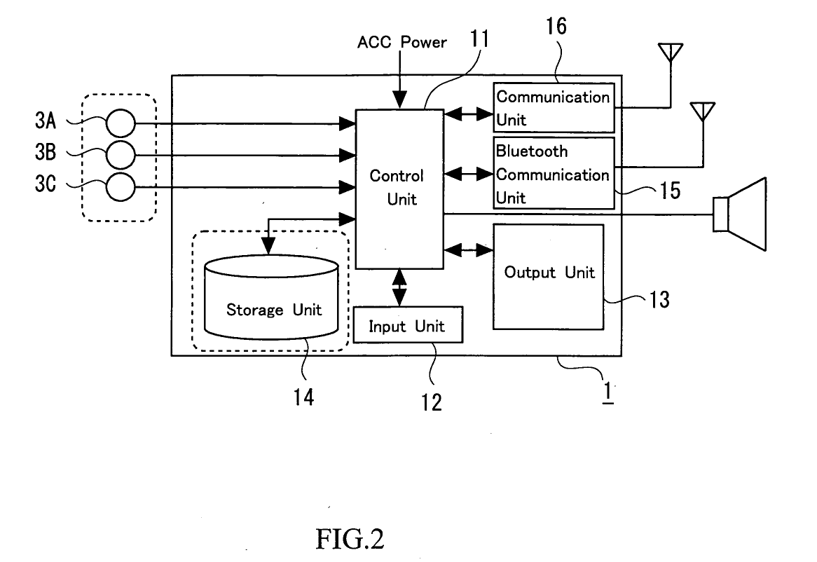

FIG. 2 is a diagram showing a configuration of the on-vehicle device 1. The on-vehicle device 1 includes a CPU and has various data processing functions. It includes a control unit 11 for controlling each processing, an input unit 12 that is constituted of an operation button, a hardware switch such as a remote controller or a software switch such as a touch panel arranged in a display unit etc. to input various data, an output unit 13 that is constituted of a liquid crystal display or a speaker etc. to output various data, a storage unit 14 that is constituted of a memory to store various data, a Bluetooth communication unit 15 as a radio communication unit connected to a mobile communication terminal by Bluetooth radio communication, and a communication unit 16 connected to various information distribution centers through various networks. The control unit 11 is connected to sensors 3A to 3C. According to the embodiment, the output unit 13 is disposed in the on-vehicle device 1. However, the output unit 13 and the on-vehicle device 1 may be separately disposed.

The mobile communication terminals only need to include a Bluetooth function, and a portable telephone, a personal digital assistance (PDA), or the like can be used. The sensors 3A to 3C determine whether a driver is in a car or not. The sensor 3A is a seating sensor, the sensor 3B is a seatbelt fastening detection sensor, and the sensor 3C is a door opening/closing sensor.

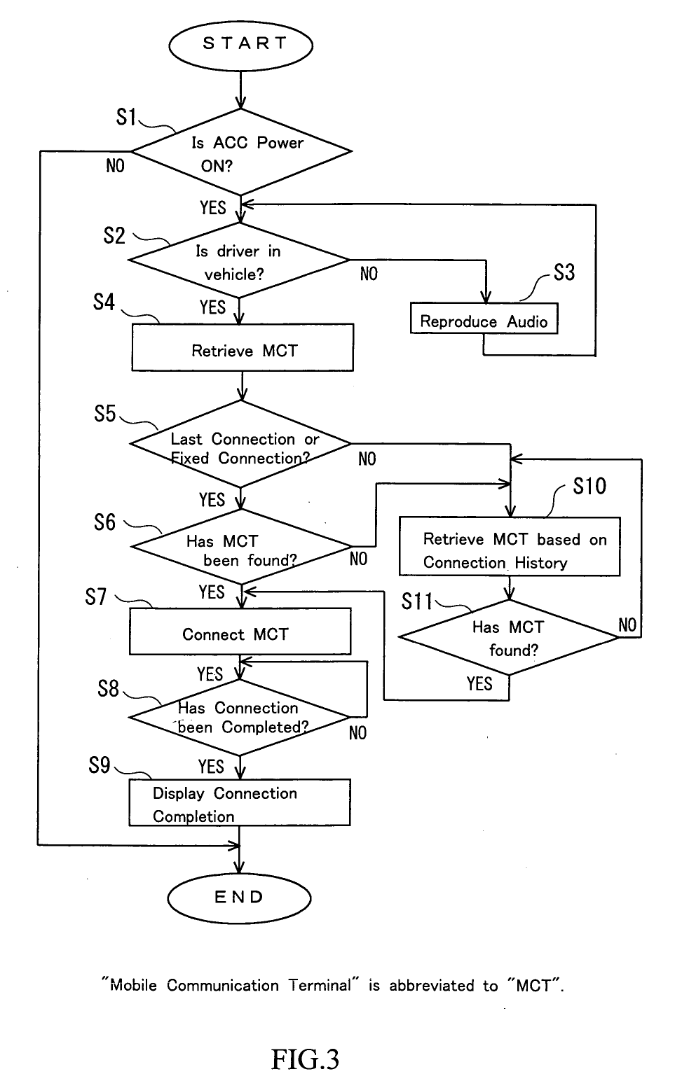

Referring to FIG. 3, the first embodiment that uses the communication system shown in FIG. 1 will be described. FIG. 3 is a flowchart showing a procedure in the on-vehicle device 1 of the first embodiment. This processing is repeatedly executed.

When ACC power is turned ON (Step S1), the on-vehicle device 1 determines whether a driver is in a vehicle or not (Step S2). The determination as to whether the driver is in the vehicle or not is carried out with the seating sensor 3A disposed in a driver's seat and the seatbelt fastening detection sensor 3B for detecting seatbelt fastening. The presence of the driver in the vehicle is judged by reaction of the two sensors. Upon determination that the driver is not in the vehicle, the on-vehicle device 1 reproduces an audio (Step S3) to wait until the driver gets in.

When a person other than the driver starts a vehicle engine while the driver is not in the vehicle, connection between the radio communication unit and the mobile communication terminal causes a possibility that a mobile communication terminal owned by a person other than the driver will be connected. However, this possibility can be eliminated by determining whether the driver is in the vehicle or not.

Upon determination that the driver is in the vehicle, the on-vehicle device 1 retrieves a mobile communication terminal to be connected (Step S4). According to the first embodiment, five mobile communication terminals 2A to 2E are registered in the on-vehicle device 1, and three of the five mobile communication terminals 2A to 2C are in a Bluetooth coverage area.

The on-vehicle device 1 determines “last connection” or “fixed connection” regarding a method of selecting a mobile communication terminal to be connected (Step S5). The last connection is a connection method of preferentially connecting last-connected one of the mobile communication terminals registered in the on-vehicle device 1. The fixed connection is a connection method of preferentially connecting a mobile communication terminal preset by the user. According to the first embodiment, the two connection methods of the last connection and the fixed connection are used. However, one of the two may be used, and can be set as occasion demands.

The on-vehicle device 1 retrieves a mobile communication terminal to be connected by the connection method when one of the last connection and the fixed connection is determined. This mobile communication terminal to be connected is selected by referring to a mobile communication terminal database (DB) stored in the storage unit 14 of the on-vehicle device 1.

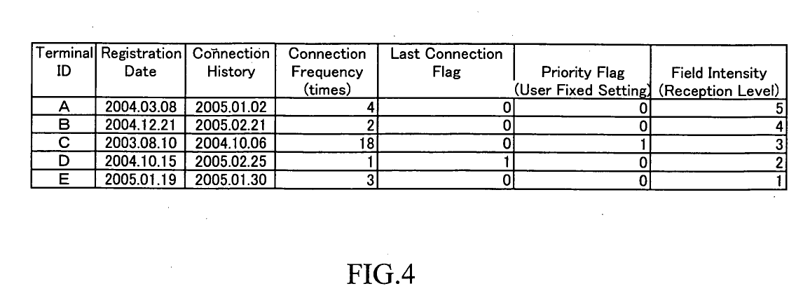

FIG. 4 shows the mobile communication terminal DB. In the mobile communication terminal DB, a terminal ID for specifying a mobile communication terminal, a registration date, connection history, a connection frequency, a last connection flag, a priority flag, and field intensity are recorded in a correlated manner. The mobile communication terminal DB corresponds to a connection history storage unit of the present invention.

The registration date is a date of registering a mobile communication terminal in the on-vehicle device 1, and the connection history is the date of last connection with the Bluetooth communication unit 15. The connection frequency indicates the number of connecting times with the Bluetooth communication unit 15. A connection frequency can be calculated based on this number of connecting times. The last connection flag is a flag indicating a mobile communication to be connected in the case of the last connection. In FIG. 3, a last connection flag is added to a terminal ID: D of latest connection history.

The priority flag is a flag indicating a terminal to be preferentially connected when the fixed connection is carried out, and preset through an input from the user. According to the first embodiment, a priority flag is added to a terminal ID: C. The field intensity indicates intensity of an electric field (degree of connectivity) calculated based on an area of covering an electric wave for each maker and a position of the vehicle.

The on-vehicle device 1 retrieves a mobile communication terminal 2D of the terminal ID: D to which the last connection flag has been added by referring to the mobile communication terminal DB in the case of connection by the last connection. When the mobile communication terminal 2D is found as a result of the retrieval (Step S6), the mobile communication terminal 2D is connected to the Bluetooth communication unit 15 (Step S7).

The on-vehicle device 1 waits for completion of connection between the mobile communication terminal 2D and the radio communication unit (Step S8), and displays the completion of the connection in the output unit 13 of the on-vehicle device 1 (Step S9) to finish the processing.

However, according to the first embodiment, the mobile communication terminal 2D is outside the Bluetooth coverage area, and cannot be discovered. Thus, when the mobile communication terminal 2D cannot be found as a result of the detection in Step S6, a mobile communication terminal to be connected is retrieved based on connection history (Step S10). When the connection is determined to be neither last connection nor fixed connection in Step S5, the mobile communication terminal to be connected is retrieved based on the connection history (Step S10).

Selection of the mobile communication terminal based on the connection history can be carried out based on first to third selection patterns. The first selection pattern is for selection based on a connection frequency, and a mobile communication terminal of a high connection frequency is determined that it is high in using possibility to be preferentially connected.

The second selection pattern is for selection based on a registration date. A mobile communication terminal of a new registration date has high possibility of having recently been used, and thus it is preferentially connected. The third selection pattern is for selection based on a connection date and time, and a mobile communication terminal of latest connection date and time is preferentially connected.

The selection patterns may be preset in the on-vehicle device 1, or properly set by the user. Each of the selection patterns may be selected to be used, or they may be used in combination as much as possible.

The on-vehicle device 1 selects a mobile communication terminal to be connected based on the selection patterns to retrieve the same. When the mobile communication terminal is found (Step S11), the mobile communication terminal is connected to the Bluetooth communication unit 15 (Step S7). Thereafter, upon completion of the connection (Step S8), the completion of the connection is displayed on a display screen of the output unit 13 (Step S9), and the processing is finished.

According to the on-vehicle device, when the mobile communication terminal is retrieved based on the last connection or the fixed connection, but the retrieved mobile communication terminal is not present, priority of a mobile communication terminal to be connected can be set by using another connection logic. Thus, an optimal mobile communication terminal can be connected according to a use state even when the user makes no proper selection, whereby a selection operation load of the mobile communication terminal on the user can be reduced.

<Second Embodiment>

An on-vehicle device of a second embodiment is directed to reconnection when a link loss occurs during connection between a Bluetooth communication unit 15 and a mobile communication terminal. The on-vehicle device of the second embodiment is directed to a case where a link loss occurs during calling of a mobile communication terminal A used by a driver.

A communication system configuration diagram and a configuration diagram of the on-vehicle device of the second embodiment are similar to those of the first embodiment. Similar components are denoted by the same reference numerals, and description thereof will be omitted.

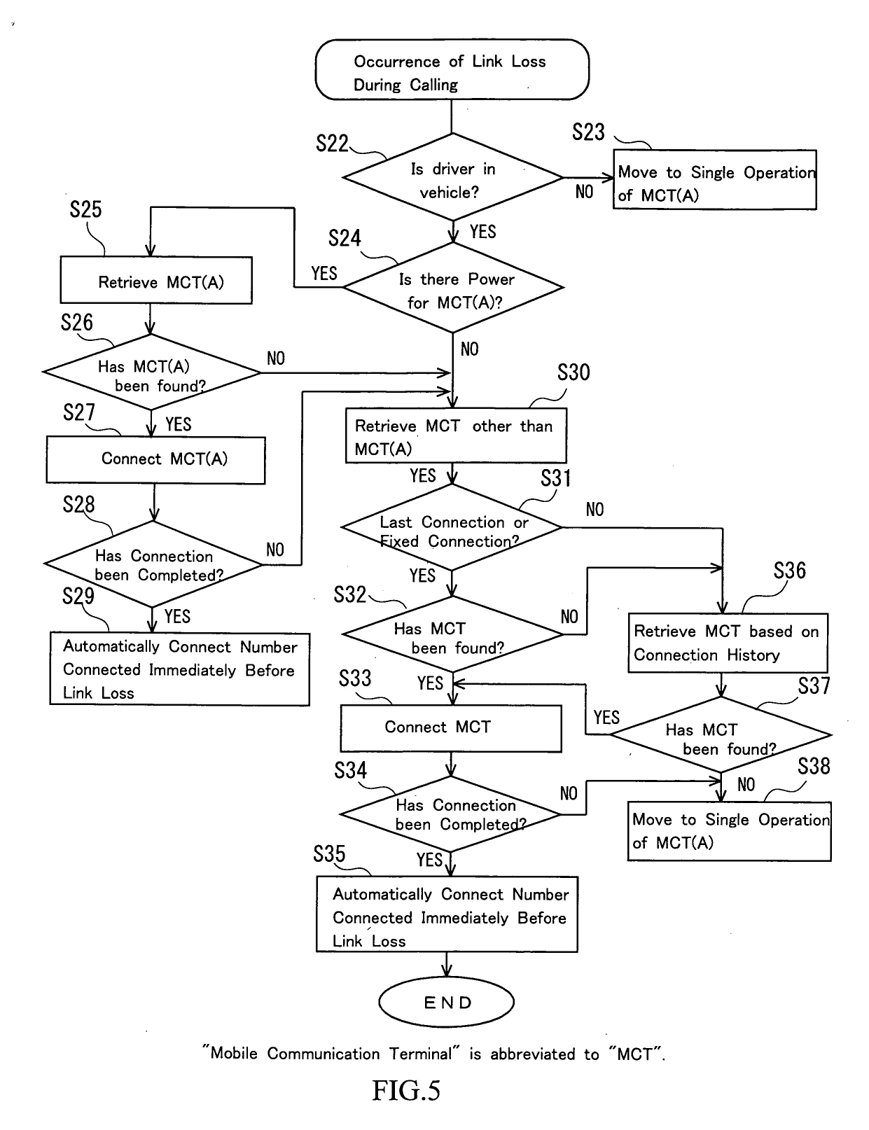

FIG. 5 is a flowchart showing a procedure in the on-vehicle device of the second embodiment. Referring to this flowchart, processing in the on-vehicle device 1 will be described. The processing is executed when a link loss occurs during calling of the mobile communication terminal A connected to the Bluetooth communication unit 15. The on-vehicle device 1 determines whether a driver of the mobile communication terminal A is in a vehicle or not (Step S22).

The link loss occurs due to various causes. Examples are lack of power of a mobile communication terminal, an erroneous operation, and electronic jamming by obstacles. The determination as to whether the driver is in the vehicle is carried out based on sensors 3A to 3C. According to the second embodiment, when either three conditions of (1) stop of the vehicle, (2) door's opening/closing of a diver's seat, and (3) not fastening of a seatbelt, or two conditions of (1) stop of the vehicle and (2) not seating of a driver in a driver's seat are satisfied, it is determined that the driver is not in the vehicle.

The on-vehicle device 1 switches to a single operation of the mobile communication terminal A when a result of the determination shows that the deriver is not in the vehicle (Step S23).

On the other hand, when a result of the determination shows that the driver is in the vehicle or gets in, presence of power for the mobile communication terminal A is determined (Step S24). The presence of power can be determined by obtaining a charged state of the mobile communication terminal A by the on-vehicle device 1 to store it in a storage unit 14. When a result of the determination shows that there is power for the mobile communication terminal A, the mobile communication terminal A is retrieved to connect it to the Bluetooth communication unit 15 (Step S25).

Next, the on-vehicle device 1 determines discovery of the mobile communication terminal A (Step S26). When it is found, the mobile communication terminal A is connected to the Bluetooth communication unit 15 (Step S27). The on-vehicle device 1 determines completion of the connection (Step S28). Upon completion of the connection, a phone number connected immediately before the link loss is automatically called (Step S29).

If it is determined in Step S24 that there is no power for the mobile communication terminal A, a mobile communication terminal other than the mobile communication terminal A is retrieved (Step S30). When the mobile communication terminal A cannot be found, or when the mobile communication terminal A is found but cannot be connected, a mobile communication terminal other than the mobile communication terminal A is similarly retrieved (Step S30).

The retrieval is similar to that of the first embodiment, and can be carried out by various connection methods such as fixed connection, last connection, connection based on connection history, and connection based on a combination thereof. The on-vehicle device 1 first determines last connection or fixed connection (Step S31). In the case of the last connection or the fixed connection, it refers to the mobile communication terminal DB to retrieve a relevant communication terminal.

The on-vehicle device 1 determines discovery of the relevant mobile communication terminal (Step S32). When the mobile communication terminal is found, the mobile communication terminal is connected to the Bluetooth communication unit 15 (Step S33). Processing thereafter is similar. Upon completion of the connection (Step S34), a phone number connected immediately before the link loss is automatically called (Step S35).

When neither the last connection nor the fixed connection is determined in Step S31, a mobile communication terminal to be connected is retrieved based on connection history (Step S36). The retrieval of the mobile communication terminal is selection based on a connection frequency, a registration date, and a connection date and time, which are first to third selection patterns as in the case of the first embodiment. Next, the on-vehicle device 1 determines discovery of the mobile communication terminal (Step S37). When the mobile communication terminal is found, the mobile communication terminal is connected to the Bluetooth communication unit 15 (Step S33). Subsequent steps 34 and 35 are similar to the above.

When the found mobile communication terminal cannot be connected to the Bluetooth communication unit 15 in the steps 37 and 34, the on-vehicle device 1 switches to a single operation of the mobile communication terminal A where the link loss occurs during the calling (Step S38), and the processing is finished.

As described above, the on-vehicle device of the second embodiment selects the mobile communication terminal to be connected according to the presence of the driver in the vehicle when the driver goes out of the vehicle during use (calling) of the mobile communication terminal A. In other words, as the presence of the mobile communication terminal to be connected in the vehicle is determined and the mobile communication terminal is connected, it is possible to carry out efficient connection work by reducing a useless retrieval operation. Besides, as the mobile communication terminal to be connected is selected based on the connection history or the like when the mobile communication terminal other than the mobile communication terminal A is connected, it is possible to select a mobile communication terminal according to user's use state.

According to the second embodiment, the lack of power of the mobile communication terminal A is determined. When the lack of power is determined, another mobile communication terminal is retrieved without retrieving the mobile communication terminal A. With this configuration, retrieval processing of the mobile communication terminal which cannot be connected can be omitted, and a connectable mobile communication terminal is efficiently retrieved to enable quick processing.

<Third Embodiment>

An on-vehicle device of a third embodiment is similar to that of the second embodiment, and is directed to reconnection when a link loss occurs during connection between a Bluetooth communication unit 15 and a mobile communication terminal A. The on-vehicle device of the third embodiment is directed to a case where a link loss occurs in a standby mode of a mobile communication terminal A used by a driver.

A communication system configuration diagram and a configuration diagram of the on-vehicle device 1 of the third embodiment are similar to those of the first embodiment. Similar components are denoted by the same reference numerals, and description thereof will be omitted.

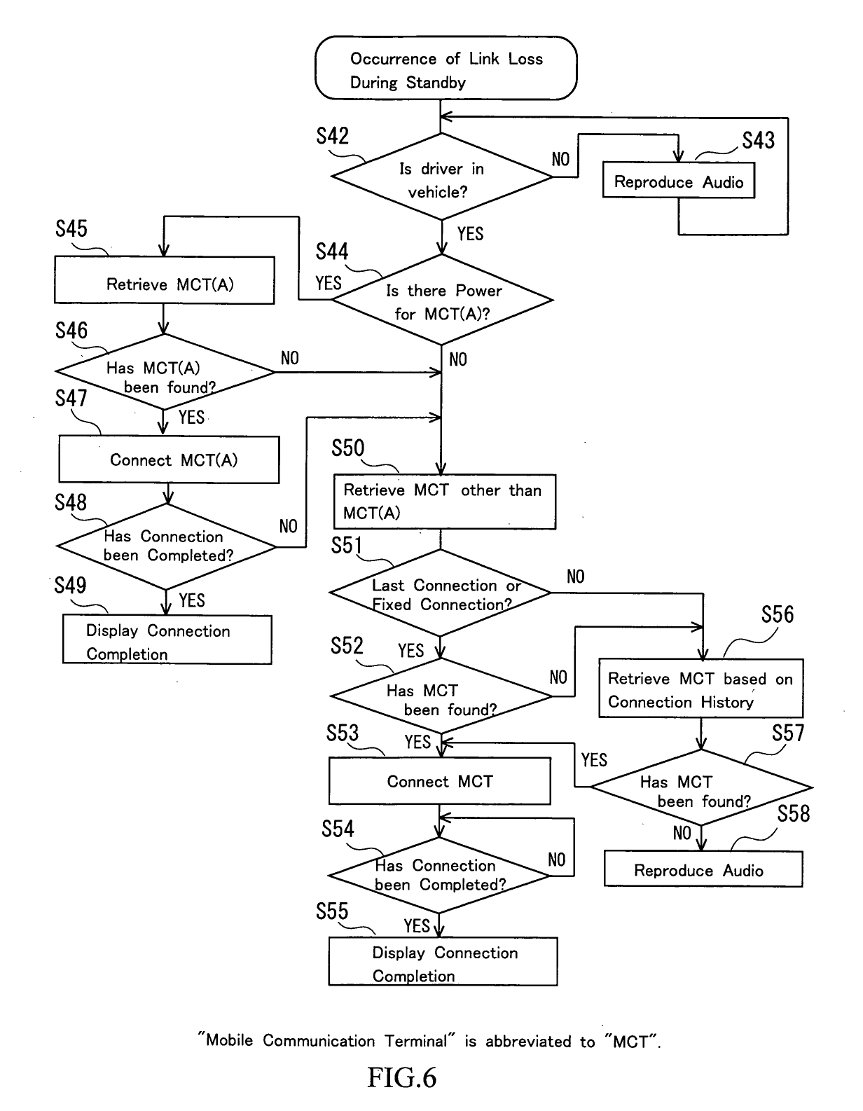

FIG. 6 is a flowchart showing a procedure in the on-vehicle device of the third embodiment. Referring to this flowchart, processing in the on-vehicle device 1 will be described. The processing is executed when a link loss occurs in a standby mode of the mobile communication terminal A connected to the Bluetooth communication unit 15. The on-vehicle device 1 determines whether a driver with the mobile communication terminal A is in a vehicle or not (Step S42). The determination of whether the driver is in a vehicle or not is similar to that of the second embodiment, and description thereof will be omitted.

When a result of the determination shows that the driver is not in the vehicle, the on-vehicle device 1 reproduces an audio (Step S43), and waits until the driver gets in.

If it is determined in Step S42 that the driver is in the vehicle, presence of power for the mobile communication terminal A is determined (Step S44). When a result of the determination shows that there is power for the mobile communication terminal A, the mobile communication terminal A is retrieved to connect it to the Bluetooth communication unit 15 (Step S45).

Next, the on-vehicle device 1 determines discovery of the mobile communication terminal A (Step S46). When it is found, the mobile communication terminal A is connected to the Bluetooth communication unit 15 (Step S47). The on-vehicle device 1 determines completion of the connection (Step S48). Upon completion of the connection, the completion of the connection is displayed on a display screen of the output unit 13 (Step S49).

If it is determined in Step S44 that there is no power for the mobile communication terminal A, a mobile communication terminal other than the mobile communication terminal A is retrieved (Step S50). When the mobile communication terminal A cannot be found in Step S46, or when the mobile communication terminal A is found but cannot be connected in Step S48, a mobile communication terminal other than the mobile communication terminal A is retrieved (Step S50).

The retrieval of the mobile communication terminal other than the mobile communication terminal A is similar to that of the second embodiment. The on-vehicle device 1 first determines last connection or fixed connection (Step S51). In the case of the last connection or the fixed connection, it refers to the mobile communication terminal DB to retrieve a relevant communication terminal.

Next, the on-vehicle device 1 determines discovery of the relevant mobile communication terminal (Step S52). When the mobile communication terminal is found as a result of the determination, the mobile communication terminal is connected to the Bluetooth communication unit 15 (Step S53). Upon completion of the connection (Step S54), the on-vehicle device 1 displays the completion of the connection on a display screen of the output unit 13 (Step S55).

When, in Step S51, neither the last connection nor the fixed connection is determined, or the mobile communication terminal is not found though either the last connection or the fixed connection is established, a mobile communication terminal to be connected is retrieved based on connection history (Step S56). The retrieval of the mobile communication terminal is similar to that of the second embodiment.

The on-vehicle device 1 determines discovery of the mobile communication terminal (Step S57). When the mobile communication terminal is found, the mobile communication terminal is connected to the Bluetooth communication unit 15 (Step S53). When the mobile communication terminal is not found, the on-vehicle device 1 reproduces an audio and the processing is finished.

As described above, the on-vehicle device of the third embodiment selects the mobile communication terminal to be connected according to the presence of the driver in the vehicle when the driver goes out of the vehicle having the mobile communication terminal A in a standby mode. In other words, as the presence of the mobile communication terminal to be connected in the vehicle is determined and the mobile communication terminal is connected, it is possible to carry out efficient connection work by reducing a useless retrieval operation. Besides, as the mobile communication terminal to be connected is selected based on the connection history or the like when the mobile communication terminal other than the mobile communication terminal A is connected, it is possible to select a mobile communication terminal according to user's use state.

According to the first to third embodiments, the configuration is adopted where the mobile communication terminal to be connected to the Bluetooth communication unit 15 is selected based on the connection history or the like, and automatically connected. However, a mobile communication terminal unintended by the user may be connected. Considering such a case, a reconnection reception unit may be disposed in the on-vehicle device 1 to receive reconnection.

For example, a configuration can be adopted where “Reconnect Button” is disposed on the display screen of the output unit. The user presses the button to display a currently connectable mobile communication terminal, and can select a mobile communication terminal to be connected. By disposing the reconnection button, it is possible to reduce a user's operation load normally through automatic selection and to reflect user's intension through executing reconnection when necessary.

The on-vehicle devices of the preferred embodiments of the present invention have been described. However, the embodiments are in no way limitative of the invention. Combinations thereof are within the invention as much as possible.

1. An on-vehicle device which is mounted on a vehicle and can be connected to a plurality of mobile communication terminals, comprising:
a radio communication unit that is connected to the mobile communication terminals to perform radio communication;
a connection history storage unit that stores connection history of the mobile communication terminals connected to the radio communication unit;
a terminal retrieval unit that retrieves mobile communication terminals in a coverage area of the radio communication unit;
a latest terminal retrieval unit that retrieves a mobile communication terminal whose connection history stored in the connection history storage unit is latest among the mobile communication terminals retrieved by the terminal retrieval unit; and
a connection control unit that, when the latest terminal retrieval unit retrieves the mobile communication terminal of the latest connection history, connects the mobile communication terminal and the radio communication unit to each other, and that, when the latest terminal retrieval unit does not retrieve the mobile communication terminal of the latest connection history, selects a mobile communication terminal of a highest frequency of being connected to the radio communication unit to connect the mobile communication terminal and the radio communication unit to each other.

2. An on-vehicle device which is mounted on a vehicle and can be connected to a plurality of mobile communication terminals, comprising:
a radio communication unit that is connected to pre-reregistered mobile communication terminals to perform radio communication;
a registration reception unit that receives registration of the mobile communication terminals to be connected to the radio communication unit;
a connection history storage unit that stores connection history of the mobile communication terminals connected to the radio communication unit;
a terminal retrieval unit that retrieves mobile communication terminals in a coverage area of the radio communication unit;
a latest terminal retrieval unit that retrieves a mobile communication terminal whose connection history stored in the connection history storage unit is latest among the mobile communication terminals retrieved by the terminal retrieval unit; and
a connection control unit that, when the latest terminal retrieval unit retrieves the mobile communication terminal of the latest connection history, connects the mobile communication terminal and the radio communication unit to each other, and that, when the latest terminal retrieval unit does not retrieve the mobile communication terminal of the latest connection history, selects a mobile communication terminal of a latest date of registration in the registration reception unit to connect the mobile communication terminal and the radio communication unit to each other.

3. An on-vehicle device which is mounted on a vehicle and can be connected to a plurality of mobile communication terminals, comprising:
a radio communication unit that is connected to the mobile communication terminals to perform radio communication;
a connection history storage unit that stores connection history of the mobile communication terminals connected to the radio communication unit;
a terminal retrieval unit that retrieves mobile communication terminals in a coverage area of the radio communication unit;
a latest terminal retrieval unit that retrieves a mobile communication terminal whose connection history stored in the connection history storage unit is latest among the mobile communication terminals retrieved by the terminal retrieval unit; and
a connection control unit that, when the latest terminal retrieval unit retrieves the mobile communication terminal of the latest connection history, connects the mobile communication terminal and the radio communication unit to each other, and that, when the latest terminal retrieval unit does not retrieve the mobile communication terminal of the latest connection history, selects a mobile communication terminal of the latest connection history of the other mobile communication terminals to connect the mobile communication terminal and the radio communication unit to each other.

4. An on-vehicle device which is mounted on a vehicle and can be connected to a plurality of mobile communication terminals, comprising:
a radio communication unit that is connected to the mobile communication terminals to perform radio communication;
a connection history storage unit that stores connection history of the mobile communication terminals connected to the radio communication unit;
a terminal retrieval unit that retrieves mobile communication terminals in a coverage area of the radio communication unit;
a connection setting reception unit that receives beforehand setting of one mobile communication terminal to be connected to the radio communication unit among the plurality of mobile communication terminals; and
a connection control unit that, when the terminal retrieval unit retrieves the mobile communication terminal set in the connection setting reception unit, connects the mobile communication terminal and the radio communication unit to each other, and that, when the terminal retrieval unit does not retrieve the mobile communication terminal set in the connection setting reception unit, selects a mobile communication terminal of a highest frequency of being connected to the radio communication unit to connect the mobile communication terminal and the radio communication unit to each other.

5. An on-vehicle device which is mounted on a vehicle and can be connected to a plurality of mobile communication terminals, comprising:
a radio communication unit that is connected to pre-reregistered mobile communication terminals to perform radio communication;
a registration reception unit that receives registration of the mobile communication terminals to be connected to the radio communication unit;
a terminal retrieval unit that retrieves mobile communication terminals in a coverage area of the radio communication unit;
a connection setting reception unit that receives beforehand setting of one mobile communication terminal to be connected to the radio communication unit among the plurality of mobile communication terminals; and
a connection control unit that, when the terminal retrieval unit retrieves the mobile communication terminal set in the connection setting reception unit, connects the mobile communication terminal and the radio communication unit to each other, and that, when the terminal retrieval unit does not retrieve the mobile communication terminal set in the connection setting reception unit, selects a mobile communication terminal of a latest date of registration in the registration reception unit to connect the mobile communication terminal and the radio communication unit to each other.

6. An on-vehicle device which is mounted on a vehicle and can be connected to a plurality of mobile communication terminals, comprising:
a radio communication unit that is connected to the mobile communication terminals to perform radio communication;
a connection history storage unit that stores connection history of the mobile communication terminals connected to the radio communication unit;
a terminal retrieval unit that retrieves mobile communication terminals in a coverage area of the radio communication unit;
a connection setting reception unit that receives beforehand setting of one mobile communication terminal to be connected beforehand to the radio communication unit among the plurality of mobile communication terminals; and
a connection control unit that, when the terminal retrieval unit retrieves the mobile communication terminal set in the connection setting reception unit, connects the mobile communication terminal and the radio communication unit to each other, and that, when the terminal retrieval unit does not retrieve the mobile communication terminal set in the connection setting reception unit, selects a mobile communication terminal whose connection history stored in the connection history storage unit is latest to connect the mobile communication terminal and the radio communication unit to each other.

7. The on-vehicle device according to claim 1, further comprising a user detection unit that determines whether a user is in a seat of the vehicle or not,
wherein the connection control unit controls the connection between the mobile communication terminal and the radio communication unit when the user detection unit detects the user's existence.

8. The on-vehicle device according to claim 1, further comprising a reconnection control unit that, when the connection is cut off while the radio communication unit and the mobile communication unit are connected to each other, prompts the connection control unit to reconnect the mobile communication terminal and the radio communication unit to each other,
wherein the connection control unit preferentially connects the mobile communication terminal and the radio communication unit which have been disconnected when the reconnection between mobile communication terminals and the radio communication unit is established.

9. The on-vehicle device according to claim 1, wherein the radio communication unit performs radio communication based on a Bluetooth™ system.
